(19) United States
(12) Patent Application Publication
(10) Pub. No.: US 2011/0130497 A1
(43) Pub. Date: Jun. 2, 2011

(54) Substitued Phosphazene Compounds and their Use as Flame Resistance Additives for Organic Polymers

(76) Inventors: Kenny C. Su, Hsinchu (CN); Jinder Jow, Missouri City, TX (US); Journey L. Zhu, Shanghai (CN); Xiaozhen Tang, Xhanghai (CN); Polaris Bai, Shanghai (CN); Steven D. Liu, Shanghai (CN); Shih-Yaw Lai, Marlboro, NJ (US)

(21) Appl. No.: 12/740,975

(22) PCT Filed: Nov. 2, 2007
(86) PCT No.: PCT/CN07/71014

§ 371 Date: Feb. 11, 2011

(51) Int. Cl. C08K 5/5399; C07F 9/6593; C09K 21/00

(52) U.S. Cl. 524/120; 558/75; 252/609

(57) ABSTRACT

Cyclic phosphazene compounds that are substituted with phosphorus-containing groups are effective flame retardants for organic polymers.

The present invention relates to flame resistance additives for organic polymers, and in particular phosphazene-type flame resistance additives.

Flame resistance (FR) additives are commonly added to polymer products used in construction, automotive, electronic, electrical laminate, wire and cable, textile and other applications. FR additives increase the limiting oxygen index (LOI) of polymer systems, allowing articles made from those polymer systems to pass standard fire tests. Various low molecular weight (<˜1500 g/mol) brominated compounds are used as FR additives for organic polymers. Many of these, such as hexabromocyclododecane and polybrominated diphenylethers, are under regulatory and public pressure that may lead to restrictions on their use, and there is an incentive to find a replacement for them.

Various phosphorus compounds have been used as FR additives. These include organic phosphates, phosphonates and phosphoramides, some of which are described in U.S. Pat. Nos. 4,070,336 and 4,086,205, as well as in “The Chemistry and Use of Flame Retardants”, J. W. Lyons, Chapter 2: Chemistry of Fire Retardants Based on Phosphorous p. 29-74 (1987). Another commercially available FR additive is 2,2′-oxybis[5,5-dimethyl-1,3,2-dioxaphosphorinane 2,2′-disulfide], which has the structure:

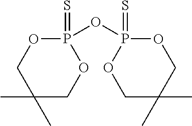

These compounds tend to provide moderate ignition resistance, and are generally not as effective as hexabromocyclododecane or other brominated FR additives.

Phosphazenes are a class of phosphorus compounds that contain a chain of alternating phosphorus and nitrogen atoms. Phosphazenes can be linear or cyclic in structure. Certain compounds of both types have been tried as FR additives in specific polymer systems. U.S. Pat. No. 3,994,996 describes compounds having multiple cyclic phosphazene moieties that are bonded together through P—O—P bonds. Those compounds are said to be useful FR additives for rayon. In U.S. Pat. No. 4,864,047, aminophenoxycyclotriphosphazenes are said to be useful as flame retardants for polystyrene. U.S. Pat. No. 6,265,599 describes amino-containing cyclic phosphazenes as a flame retardant for polyurethane and epoxy resins. EP 0 214 351 describes sulfur-containing cyclic phosphazenes as flame retardants for acrylate and methacrylate resins. JP 2004-051697A describes certain other cyclic phosphazenes as FR additives for a variety of polymers, including polyolefins, polystyrene and styrene copolymers, polycarbonates, poly(ethylene terephthalate), polybutadiene, polyamides, epoxy resins and unsaturated polyesters, as well as others. JP 2001-018475AA describes cyclic phosphazenes substituted with phosphorus- and/or nitrogen-containing groups. These are described as flame retardants for a variety of polymers, similar to those described in UP 2004-051697. JP 51-037149A, JP 2001-200151A and U.S. Published Application No. 2005-0245670 all describe certain substituted cyclic phosphazenes as FR additives in polycarbonate resin compositions.

Despite numerous attempts such as these, phosphazene compounds have found little commercial success. Although phosphazene compounds can provide flame retardancy (as indicated by certain standardized tests), they often do not have other attributes that are necessary in a good FR additive. In some cases, the phosphazene compounds are simply too expensive to be practical. Many of the phosphazene FR additives have been found to be inefficient, and require somewhat large loadings in order to be effective. Sometimes, the phosphazene compounds are not sufficiently miscible in particular organic polymers. Because of this, it is difficult to distribute the phosphazene compound uniformly into the polymer. This leads to inconsistent performance and in some cases the loss of the FR additive from the polymer over time, due to bleeding or other processes. Poor miscibility can also lead to serious processing problems. In some cases, an effective amount of the phosphazene compound cannot be introduced into the polymer because of poor miscibility.

Yet another problem with some phosphazene FR additives is that they are not thermally stable at the temperatures at which certain organic polymers are melt-processed. This is particularly the case when the polymer is melt processed at temperatures above about 230° C. Many of the phosphazene compounds begin to degrade at those temperatures, leading to the formation of decomposition products and, of course, loss of the additive.

It is desirable to provide an alternative FR additive for organic polymers, and for foamed polymers in particular. The FR additive should be capable of raising the LOI of the polymer system when incorporated into the polymer at reasonably low levels. Similarly, the FR additive should be capable of conferring good fire extinguishing properties to the polymer system (as determined using standardized test methods), again when present at reasonably small levels. Because in many cases the FR additive is most conveniently added to a melt of the organic polymer, or else (or in addition) is present in subsequent melt processing operations, the FR additive should be thermally stable at the temperature at which the polymer is melt processed. Preferably, the FR additive is thermally stable to a temperature of at least 230° C.

### SUMMARY OF THE INVENTION

The present invention is in one aspect a phosphazene compound represented by the structure I:

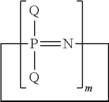

wherein:
(1) m is a number of from 3 to 20,
(2) each Q group is a Q¹ group or Q² group provided that at least one Q group on the phosphazene compound is a Q¹ group and at least one Q group on the phosphazene compound is a Q² group,
(3) each Q¹ group is independently a phosphate group represented by the structure II:

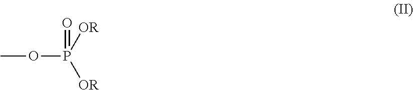

wherein each R is independently an unsubstituted or substituted hydrocarbyl group which contains no halogen atoms,
(4) each Q² group is an unsubstituted or substituted aryloxy or alkoxy group that contains no phosphorus atoms and no halogen atoms,
(5) the Q groups bonded to any particular phosphorus atom may form a ring structure that includes that phosphorus atom, and
(6) the cyclic phosphazene additive contains at least 7% by weight of phosphorus atoms.

The present invention is in one aspect a polymer composition comprising a combustible polymer having mixed therein an effective amount of a cyclic phosphazene additive represented by the structure I:

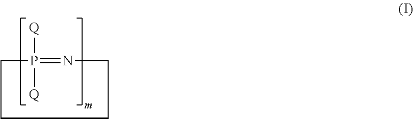

wherein:
(1) m is a number of from 3 to 20,
(2) each Q group is a Q¹ group or Q² group provided that at least one Q group on the phosphazene compound is a Q¹ group and at least one Q group is a Q² group,
(3) each Q¹ group is independently a phosphate group represented by the structure II:

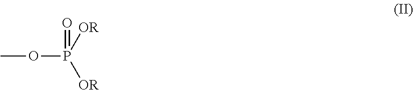

wherein each R is independently an unsubstituted or substituted hydrocarbyl group which contains no halogen atoms,
(4) each Q² group is an unsubstituted or substituted aryloxy or alkoxy group that contains no phosphorus atoms and no halogen atoms,
(5) the Q groups bonded to any particular phosphorus atom may form a ring structure that includes that phosphorus atom, and
(6) the cyclic phosphazene additive contains at least 7% by weight of phosphorus atoms.

In another aspect, the invention is a phosphazene compound represented by the structure I:

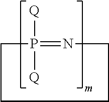

wherein:
(1) m is a number from 3 to 20,
(2) each Q group is a Q³ group or Q⁴ group provided that at least one Q group on the phosphazene compound is a Q³ group and at least one Q group on the phosphazene compound is a Q⁴ group,
(3) each Q³ group is independently is an aryloxy or alkoxy group that is substituted with at least one phosphorus atom and which contains no halogen atoms,
(4) each Q⁴ group is independently an aryloxy or alkoxy group that contains no phosphorus atoms and no nitrogen atoms,
(5) the Q groups bonded to any particular phosphorus atom in the phosphazene ring may form a ring structure that includes that phosphorus atom, and
(6) the cyclic phosphazene additive contains at least 7% by weight of phosphorus atoms.

In still another aspect, this invention is a polymer composition comprising a combustible polymer having mixed therein an effective amount of a cyclic phosphazene additive represented by structure I

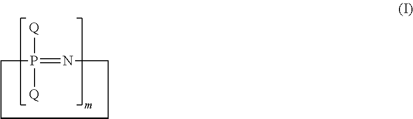

wherein:
(1) m is a number from 3 to 20,
(2) each Q group is a Q³ group or Q⁴ group provided that at least one Q group on the phosphazene compound is a Q³ group and at least one Q group on the phosphazene compound is a Q⁴ group,
(3) each Q³ group is independently is an aryloxy or alkoxy group that is substituted with at least one phosphorus atom and which contains no halogen atoms,
(4) each Q⁴ group is independently an aryloxy or alkoxy group that contains no phosphorus atoms and no nitrogen atoms,
(5) the Q groups bonded to any particular phosphorus atom in the phosphazene ring may form a ring structure that includes that phosphorus atom, and
(6) the cyclic phosphazene additive contains at least 7% by weight of phosphorus atoms.

The phosphazene compounds as described are useful flame retardants for use with various organic polymers, including engineering thermoplastics such as polycarbonate, poly(butylene terephthalate) and polyamides. These phosphazene compounds tend to be highly miscible in a variety of organic polymers, and to have sufficient thermal stability that they exhibit little or no thermal degradation at the temperatures used to melt process the organic polymer.

### DETAILED DESCRIPTION OF THE INVENTION

The cyclic phosphazene additives used in the invention contain a phosphazene ring, i.e. a cyclic structure having alternating phosphorus and nitrogen atoms. The phosphorus atoms on the ring carry substituent groups, some of which contain phosphorus atoms. Phosphorus atoms constitute at least 7% of the total weight of the cyclic phosphazene additive.

The cyclic phosphazene additives used herein can be classified into two types, characterized by the substituent groups on the phosphazene phosphorus atoms. Each type can be represented by the structure I

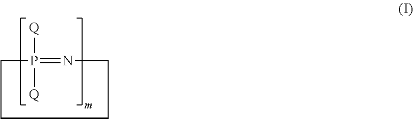

in which m is a number from 3 to 20, preferably from 3 to 10, more preferably from 3 to 5 and most preferably 3.

In additives of the first type, the Q groups are all Q¹ groups or Q² groups, provided that at least one Q¹ group is present and at least one Q² group is present in the molecule. Each Q¹ group is independently a phosphate group having the structure II:

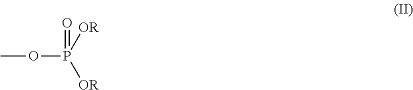

wherein each R is independently an unsubstituted or inertly substituted hydrocarbyl group which contains no halogen atoms. The R groups each preferably contain from 1 to 20 carbon atoms. The R groups can contain aliphatic, aromatic, cycloaliphatic or heterocyclic moieties, or combinations of two or more of these. The R groups can be unsubstituted, meaning that they contain only carbon and hydrogen atoms. Alternatively, the R groups may be substituted. Examples of suitable substituents include, for example, hydroxyl, ether, tertiary amine, ester, urethane, urea, and similar groups. An R group may be a linear or branched C₁-C₂₀ alkyl group such as methyl, ethyl, n-propyl, isopropyl, n-butyl, t-butyl, sec-butyl, and the like. An R group may be a phenyl (—C₆H₅) or benzyl (—CH₂—C₆H₅) group. An R group may be a phenyl group that contains alkyl substitution on the aromatic ring, such as, for example, those represented by the structure —C₆H_{(5-y)}—[(CH₂)ₓCH₃]_{y}, where x is zero or a positive number, y is from 1 to 5, and x and y are such that the group has up to 20 carbon atoms. An R group may be a biphenyl or polyphenyl group (—C₆H_{(5-z)}—(C₆H₅)_{z}, where z is 1 or 2). An R group may contain a fused ring structure (such as a naphthyl group). An R group may be alkoxy-substituted phenyl, such as (—C₆H_{(5-z)}—[O—C_{b}H_{(2b+1)}]ₓ where b is a positive number such that the R group contains up to 20 carbon atoms. A Q² group may be a phenoxy group that contains aralkyl substitution, such as —O—C₆H₄—CR¹₂—C₆H₅, where each R¹ is independently hydrogen or C₁-C₃ alkyl. An R group may be aryloxy-substituted phenyl, i.e., —C₆H_{(5-z)}—(OC₆H₅)_{z}, where z is 1 or 2. A highly preferred R group is phenyl.

The Q² groups are each an unsubstituted or inertly substituted aryloxy or alkoxy group that contains no phosphorus atoms or halogen atoms. Permissible inert substituents are as described with respect to the Q¹ groups. The Q² groups are most preferably unsubstituted or contain only ether or hydroxyl substitution. A Q² group may be a linear or branched alkoxyl group containing from 1 to 20 carbon atoms. A Q² group may be a phenoxy (—O—C₆H₅) group. A Q² group may be a phenoxy group that contains alkyl substitution, i.e., —O—C₆H_{(5-y)}—[(CH₂)ₓCH₃]_{y}, where x is zero or a positive number, y is from 1 to 5, and x and y are such that the group has up to 20 carbon atoms. A Q² group may be a phenoxy group that contains phenyl substitution, i.e., —O—C₆H_{(5-z)}—(C₆H₅)_{z}, where z is 1 or 2. A Q² group may be a phenoxy group that contains aryloxy substitution, such as —O—C₆H_{(5-z)}—(OC₆H₅)_{z}, where z is 1 or 2. A Q² group may be a phenoxy group that contains aralkyl substitution, such as —O—C₆H₄—CR¹₂—C₆H₅, where each R¹ is independently hydrogen or C₁-C₃ alkyl.

In addition, the Q groups (i.e., two Q¹ groups, two Q² groups, or one Q¹ and one Q² group) bonded to any particular phosphorus atom in the phosphazene ring may form a ring structure that includes that phosphorus atom. For example, two Q² groups may together form a divalent group, such as those represented by structures III-VI:

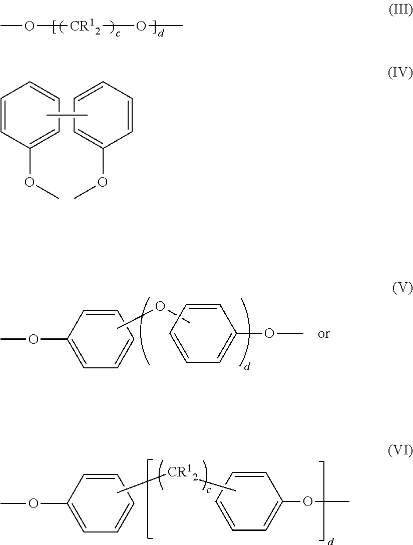

In each case, the divalent groups are bound to a single ring phosphorus atom through the terminal oxygen atoms. In the foregoing structures, R¹ is as defined before, and c and d are each at least one, provided that the group contains no more than 20 carbon atoms.

At least one Q¹ group is present and at least one Q² group is present in the first type of cyclic phosphazene additive. The number of Q¹ groups present may be as high as 2m−1, where m represents the number of phosphorus atoms in the cyclic phosphazene ring. Similarly, the number of Q² groups may also be as high as 2m−1, with the proviso that the cyclic phosphazene additive contains at least 7% by weight of phosphorus atoms. If the Q¹ and/or Q² groups are bulky, or if m is greater than 3, it may be necessary to include more than one Q¹ group in the structure to provide at least 7% phosphorus in the molecule. The phosphorus content of the molecule can be, for example, from 7 to 30% by weight, or from 10 to 20% by weight.

Especially preferred cyclic phosphazene additives of the first type are represented by structure VII:

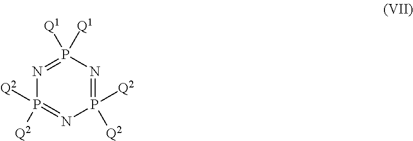

wherein Q¹ and Q² are as described before. A particularly interesting cyclic phosphazene of the first type is di-(diphenolphosphate)-di-(2,2′-dihydroxybiphenyl)cyclotriphosphazene, which has the structure:

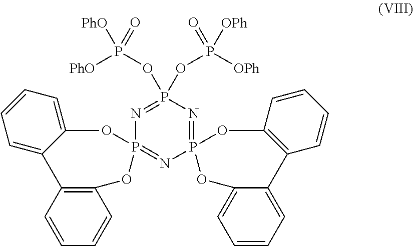

In cyclic phosphazene additives of the second type, the Q groups are all Q³ groups or Q⁴ groups, provided that at least one Q³ group is present and at least one Q⁴ group is present. Each Q³ group is independently is an aryloxy or alkoxy group that is substituted with at least one phosphorus atom and which contains no halogen atoms. One suitable Q³ group is represented by the structure:

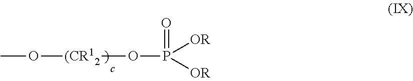

wherein R¹, c and R are as defined before. Another suitable Q³ group is represented by the structure X:

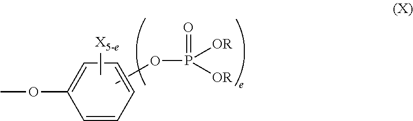

wherein R is as defined before, e is a number from 1 to 5, preferably 1 or 2, and each X is independently a hydrogen or a substituent group as described before with respect the Q¹ groups. Preferred X groups are hydrogen, alkyl, alkoxyl, aryl, and aryloxyl groups. The X groups are most preferably hydrogen. Each R is preferably C₁₋₂₀ alkyl or phenyl.

Another suitable Q³ group is represented by the structure XI:

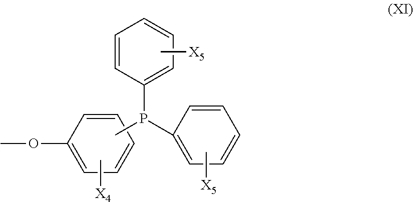

wherein X is as defined before.

The Q⁴ groups are generally the same as the Q² groups discussed before, except that the Q⁴ groups do not contain nitrogen atoms, and may (but preferably do not) contain halogen atoms. Thus, each Q⁴ group may be an unsubstituted or substituted aryloxy or alkoxy group that contains no phosphorus atoms, no nitrogen atoms and no halogen atoms. Permissible substituents are as described with respect to the Q¹ groups or Q² groups described before, except that nitrogen-containing substituents are not allowed, and halogens are permissible (although not preferred) substituents. The Q⁴ groups are most preferably unsubstituted or contain only ether or hydroxyl substitution. A Q⁴ group may be a linear or branched alkoxyl group containing from 1 to 20 carbon atoms. A Q⁴ group may be a phenoxy (—O—C₆H₅) group. A Q⁴ group may be a phenoxy group that contains alkyl substitution, i.e., —O—C₆H_{(5-y)}—[(CH₂)ₓCH₃]_{y}, where x is zero or a positive number, y is from 1 to 5, and x and y are such that the group has up to 20 carbon atoms. A Q⁴ group may be a phenoxy group that contains phenyl substitution, i.e., —O—C₆H_{(5-z)}—(C₆H₅)_{z}, where z is 1 or 2. A Q⁴ group may be a phenoxy group that contains aryloxy substitution, such as —O—C₆H_{(5-z)}—(OC₆H₅)_{z}, where z is 1 or 2. A Q⁴ group may be a phenoxy group that contains aralkyl substitution, such as —O—C₆H₄—CR¹₂—C₆H₅, where each R¹ is independently hydrogen or C₁-C₃ alkyl.

The Q³ and/or Q⁴ groups bonded to any particular phosphorus atom in the phosphazene ring may form a ring structure that includes that phosphorus atom. For example, two Q⁴ groups may together form a divalent group having any of structures III-VI above.

At least one Q³ group is present and at least one Q⁴ group is present in the second type of cyclic phosphazene additive. The number of Q³ groups present may be as high as 2m-1, where m represents the number of phosphorus atoms in the cyclic phosphazene ring. Similarly, the number of Q⁴ groups may also be as high as 2m-1, with the proviso that the cyclic phosphazene additive contains at least 7% by weight of phosphorus atoms. If the Q³ and/or Q⁴ groups are bulky, or if m is greater than 3, it may be necessary to include more than one Q³ group in the structure to provide at least 7% phosphorus. As before, the phosphorus content of the molecule can be, for example, from 7 to 30% by weight, or from 10 to 20% by weight.

The cyclic phosphazene additives of the first type can be prepared by introducing Q groups onto a starting cyclic phosphazene having the structure XII:

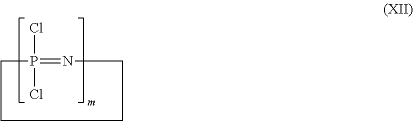

Q¹ groups can be introduced using a reagent of the form (structure XIII)

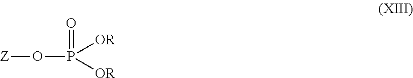

wherein Z is hydrogen, an alkali metal or a C₁-C₄ alkyl group. Z is preferably an alkali metal, especially sodium or potassium. This reagent will react at phosphorus atoms in the phosphazene starting material to displace a chlorine. HCl, an alkali metal chloride salt or an alkyl halide are formed (depending on the nature of Z), which can be removed as they are formed. The reaction can be performed at low to moderate temperatures, such as from 10 to 100° C. (although higher temperatures up to 250° C. can be used if desired), and can be performed in the presence of a solvent if desired.

Q², Q³ and Q⁴ groups can be introduced in an analogous fashion, using an alcohol or the corresponding C₁-C₄ alkyl ether or alkali metal alkoxide as a starting material. Thus, for example, Q² groups can be introduced using reagents of the forms

Z-Q² (XIV) and

Z-Q²-Z (XV)

wherein Z and Q² are as defined before. Q³ groups can be introduced using reagents of the form

Z-Q³ (XVI)

wherein Z and Q³ are as defined before. Q⁴ groups can be introduced using reagents of the forms

Z-Q⁴ (XVII) and

Z-Q⁴-Z (XVIII)

wherein Z and Q⁴ are as defined before. In structures XIV-XVIII, each Z is bonded to an oxygen atom of the Q², Q³ or Q⁴ group, as the case may be. Reagents of the form of structures XV and XVIII can react difunctionally and therefore can be used to form a ring structure that includes a phosphorus atom of the phosphazene ring. Suitable reaction temperatures are the same as described before with respect to the introduction of Q¹ groups. Again, the reaction can be performed in the presence of a solvent if desired.

It is possible to introduce the Q¹ and Q² groups in either order, or even simultaneously. Proportions of starting materials are selected to provide the desired level of substitution with each of the Q¹ and Q² groups. Similarly, Q³ and Q⁴ groups may be introduced in either order, or even simultaneously. Proportions of starting materials are selected to provide the desired level of substitution with each of the Q³ and Q⁴ groups.

The cyclic phosphazene additive is useful as a flame retardant additive for a variety of combustible polymers. “Combustible” here simply means that the polymer is capable of being burned. The combustible polymer may be a thermoplastic or thermoset polymer.

Combustible polymers of interest include polyolefins such as polyethylene (including copolymers of ethylene such as ethylene-α-olefin copolymers), polypropylene and the like; ethylene-vinyl acetate copolymers, polycarbonates and blends of polycarbonates such as blends of a polycarbonate with a polyester or blends of a polycarbonate and an acrylonitrile-styrene-butadiene (ABS) resin; vinyl aromatic polymers (including vinyl aromatic homopolymers such as polystyrene); copolymers of vinyl aromatic monomers, such as styrene-acrylonitrile copolymers and styrene-methylmethacrylate copolymers; blends of one or more vinyl aromatic homopolymers and/or vinyl aromatic copolymers with another polymer, such a poly(phenylene oxide) resin; impact-modified polystyrene resins such as ABS resins and high impact polystyrene; polyamides, particularly aromatic polyamides; polyesters; epoxy resins; polyurethanes, including both thermosetting and thermoplastic types; polyisocyanurates; vinyl ester resins; acrylate and methacrylate polymers and copolymers, poly(alkylene terephthalate) resins such as poly(ethylene terephthalate) and poly(butylene terephthalate); thermoplastic or thermoset vinyl ester resins, poly(phenylene oxide) and blends of poly(phenylene oxide) with high impact polystyrene; as well as other flammable polymers in which the cyclic phosphazene additive can be dissolved or dispersed.

The cyclic phosphazene additives are of particular interest when the organic polymer is a thermoplastic that is melt processed at a temperature of at least 230° C., especially at least 250° C.

Enough of the cyclic phosphazene additive is combined with the combustible polymer to improve the performance of the combustible polymer in one or more standard fire tests. One such test is a limiting oxygen index (LOI) test, which evaluates the minimum oxygen content in the atmosphere that is needed to support combustion of the polymer. LOI is conveniently determined in accordance with ASTM D2863. The combustible polymer containing the cyclic phosphazene preferably has an LOI at least 2%, more preferably at least 3%, higher than that of the combustible polymer alone. Another fire test is a time-to-extinguish measurement, known as FP-7, which is determined according to the method described by A. R. Ingram in J. Appl. Poly. Sci. 1964, 8, 2485⁻²⁴⁹⁵. This test measures the time required for flames to become extinguished when a polymer sample is exposed to an igniting flame under specified conditions, and the ignition source is then removed. In general, FP-7 values should be as low as possible.

The cyclic phosphazene can be combined with the combustible polymer using various melt-blending and solution blending methods. Melt-blending methods are often preferred. It is convenient in many cases to blend the cyclic phosphazene additive into the molten combustible polymer, either prior to or during another melt processing operation (such as extrusion, foaming, molding, etc.). Because of this, the cyclic phosphazene additive is preferably thermally stable at the temperature at which the molten polymer is melt-processed. This temperature is, for many engineering thermoplastics, typically above 230° C., and in many cases 250° C. or higher.

A useful indicator of thermal stability is a 5% weight loss temperature, which is measured by thermogravimetric analysis as follows: ˜10 milligrams of the cyclic phosphazene additive is analyzed using a TA Instruments model Hi-Res TGA 2950 or equivalent device, with a 60 milliliters per minute (mL/min) flow of gaseous nitrogen and a heating rate of 10° C./min, over a temperature range of from room temperature (nominally 25° C.) to 600° C. The mass lost by the sample is monitored during the heating step, and the temperature at which the sample has lost 5% of its initial weight is designated the 5% weight loss temperature (5% WLT). This method provides a temperature at which a sample has undergone a cumulative weight loss of 5 wt %, based on initial sample weight. The cyclic phosphazene additive preferably exhibits a 5% WLT of at least the temperature at which the combustible polymer is to be melt-processed (to blend it with the phosphorus-sulfur FR additive or to process the blend into an article such as a foam, extruded part, molded part, or the like). The cyclic phosphazene additive preferably has a 5% WLT of at least 230° C., more preferably at least 240° C., and still more preferably at least 250° C.

It is also possible to blend the cyclic phosphazene additive with a combustible polymer using other methods, such as mixing it into a solution of the combustible polymer, by adding it into a suspension polymerization or emulsion polymerization process, or in other ways.

Polymer blends in accordance with the invention may include other additives such as other flame retardant additives, thermal stabilizers, ultraviolet light stabilizers, nucleating agents, antioxidants, foaming agents, fillers, crosslinking and/or grafting agents, acid scavengers and coloring agents. Other flame retardant compounds that are useful in conjunction with the phosphazene compounds of the invention include, for example, various phosphates and linear polyphosphazene compounds, among others. Fluorinated polymers such as homopolymers or copolymers of tetrafluoroethane are also useful additives.

Polymer blends containing cyclic phosphazene additives in accordance with the invention may be melt or solution processed to form a wide variety of products. The blend may be processed to from a wide range of fabricated articles, including without limitation a film, sheet, fiber, foam or a molded article. Specific examples of such products include wire and cable insulation, display media, electrical and electronic parts, building and construction products, automobile frame, body and interior parts, solid polymer electrolytes, and the like.

The following examples are provided to illustrate the invention, but not to limit the scope thereof. All parts and percentages are by weight unless otherwise indicated.

### Example 1

A solution of 2,2′-dihydroxybiphenol (2.88 mmol) and acetone (15 mL) is prepared at 0° C. Solid hexachlorocyclotriphosphazene (1.44 mmol and K₂CO₃ (7.23 mmol) are then added into the solution. The mixture is allowed to warm up to room temperature and is then stirred at room temperature for 2 hours. The volatiles are evaporated under vacuum and the residue extracted 5 times with 25 mL of CH₂Cl₂. The solvent is removed under vacuum, leaving dichlorodi(2,2′-dihydroxybiphenol)cyclotriphosphazene (DCCP) as a white solid. The structure of DCCP is:

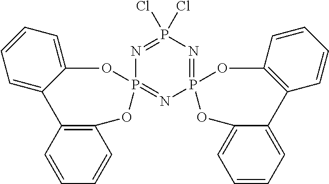

Under a nitrogen purge, 0.02 mol of diphenolchlorophosphate is added dropwise into 100 mL ethanol. Excess triethylamine is then added, and the reaction mixture is stirred for about half an hour at room temperature. The solution is then washed 3 times with 100 mL water. Diphenolethylphosphate is obtained as a light yellow oil.

0.01 mol DCCP and 0.012 mol diphenolethylphosphate are added into a flask equipped with magnetic stirrer, thermometer and condenser. Under purged nitrogen, the mixture is stirred and heated to 200° C. The reaction is allowed to reflux with stirring for 12 hours at 200° C. Then the reactor is cooled down to room temperature. The product di-(diphenolphosphate)-di-(2,2′-dihydroxybiphenyl)cyclotriphosphazene (DPPPZ), which has the structure shown below, is obtained as a transparent brown solid.

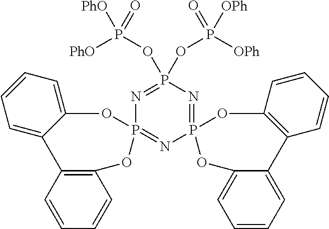

Elemental analysis indicates the product material contains 57.32% carbon, 3.72% hydrogen, 4.12% nitrogen and 15.38% phosphorus, all by weight, which is consistent with the foregoing structure. The NMR spectrum is also consistent with the foregoing structure. On thermogravimetric analysis (TGA), the 1% weight loss temperature of DPPPZ is 268° C. in nitrogen and 257° C. in air. The 5% WLT of DPPPZ is 317° C. in nitrogen and 320° C. in air.

90 parts by weight of a polycarbonate/ABS blend are mixed with 10 parts by weight of the DPPPZ compound in a HAAKE mixer. The blended material is formed into 2.8 mm-thick test samples, and flammability is measured in accordance with the UL-94 vertical burn test. Results as indicated in Table 1 below.

In a similar manner, blends containing 12% and 15% of the DPPPZ compound are made and tested. Results are as reported in Table 1.

For comparison, blends of the PC/ABS resin are made that contain 10, 12 or 15% of triphenyl phosphate (TPP), or 10, 12 or 15% of an aromatic polyphosphate (PX-200, from Daihachi Chemical Industry Co., Ltd.). These blends are evaluated according to UL-94 in the same manner as before, with results as indicated in Table 1.

TABLE 1

| | FR Agent | | | | | | | | |
|---|---|---|---|---|---|---|---|---|---|
| | DPPPZ | | | TPP* | | | PX-200* | | |
| FR loading¹ | 10% | 12% | 15% | 10% | 12% | 15% | 10% | 12% | 15% |
| t1(s)² | 9 | 6.5 | 1.5 | 16 | 9 | 1.5 | 15 | 8.5 | 1.5 |
| t2(s)² | Drips³ | Drips | 4 | Drips | Drips | 7 | Drips | Drips | 8 |

*Not an example of the invention.
¹Weight percent the FR agent, expressed as a percentage of the weight of the total blend.
²t1 is the time in seconds to extinguish after the first ignition in the UL-94 test. t2 is the time in seconds to extinguish after the second ignition in the UL-94 test.
³“Drips” means that droplets of molten blend form and fall to ignite underlying cotton.

At each loading level, the DPPPZ performs better than the TPP and the PX-200. At the 10 and 12% by weight levels, the t1 time to extinction is lowest for the DPPPZ. At the 15% by weight levels, the t2 time to extinction is lowest for the DPPPZ.

1. A phosphazene compound represented by the structure: 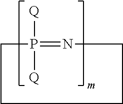
wherein:
(1) m is a number of from 3 to 20,
(2) each Q group is a Q¹ group or Q² group provided that at least one Q group on the phosphazene compound is a Q¹ group and at least one Q group on the phosphazene compound is a Q² group,
(3) each Q¹ group is independently a phosphate group represented by the structure II: 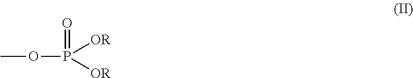
wherein each R is independently an unsubstituted or substituted hydrocarbyl group which contains no halogen atoms,
(4) each Q² group is an unsubstituted or substituted aryloxy or alkoxy group that contains no phosphorus atoms and no halogen atoms,
(5) the Q groups bonded to any particular phosphorus atom may form a ring structure that includes that phosphorus atom, and
(6) the phosphazene compound contains at least 7% by weight of phosphorus atoms.

2. The phosphazene compound of claim 1, wherein each R is independently a linear or branched C₁-C₂₀ alkyl group, a phenyl group, a benzyl group, a phenyl group that contains alkyl substitution on the aromatic ring, a biphenyl or polyphenyl group, a naphthyl group), an alkoxy-substituted phenyl group, a phenoxy group that contains aralkyl substitution, or an aryloxy-substituted phenyl group.

3. The phosphazene compound of claim 1, wherein each Q² group is independently a linear or branched alkoxyl group containing from 1 to 20 carbon atoms, a phenoxy group, a phenoxy group that contains alkyl substitution, a phenoxy group that contains phenyl substitution, a phenoxy group that contains aryloxy substitution, or a phenoxy group that contains aralkyl substitution.

4. The phosphazene compound of claim 1, wherein each R group is phenyl.

5. The phosphazene compound of claim 1, which is di-(diphenolphosphate)-di-(2,2′-dihydroxybiphenyl)cyclotriphosphazene.

6. The phosphazene compound of claim 1, wherein at least Q¹ or Q² group contains a hydroxyl, ether, tertiary amine, ester, urethane or urea group.

7. A mixture comprising the phosphazene compound of claim 1 and at least one other flame retardant.

8. A polymer composition comprising a combustible polymer having mixed therein an effective amount of the phosphazene compound of claim 1.

9. The polymer composition of claim 8, further comprising at least one filler, antioxidant, UV stabilizer, fluorinated polymer, lubricant or impact modifier.

10. A phosphazene compound represented by the structure: 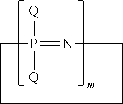
wherein:
(1) m is a number from 3 to 20,
(2) each Q group is a Q³ group or Q⁴ group provided that at least one Q group on the phosphazene compound is a Q³ group and at least one Q group on the phosphazene compound is a Q⁴ group,
(3) each Q³ group is independently is an aryloxy or alkoxy group that is substituted with at least one phosphorus atom and which contains no halogen atoms,
(4) each Q⁴ group is independently an aryloxy or alkoxy group that contains no phosphorus atoms, and no nitrogen atoms,
(5) the Q groups bonded to any particular phosphorus atom in the phosphazene ring may form a ring structure that includes that phosphorus atom, and
(6) the phosphazene compound contains at least 7% by weight of phosphorus atoms.

11. The phosphazene compound of claim 10, which contains no halogen atoms.

12. The phosphazene compound of claim 10, wherein each Q³ group is independently represented by any of the structures IX, X or XI, wherein structures IX, X and XI are: 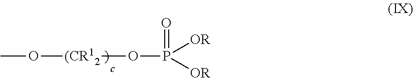
wherein each R is independently an unsubstituted or inertly substituted hydrocarbyl group which contains no halogen atoms, each R¹ is independently hydrogen or C1-C₃ alkyl, and c is a number that is at least one, provided that the total number of carbon atoms in the Q³ group is from 1 to 20; 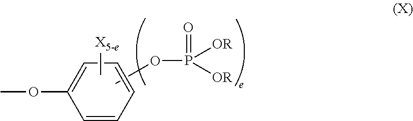
wherein each R is independently an unsubstituted or inertly substituted hydrocarbyl group which contains no halogen atoms, e is a number from 1 to 5, and each X is independently a hydrogen or a substituent group; and 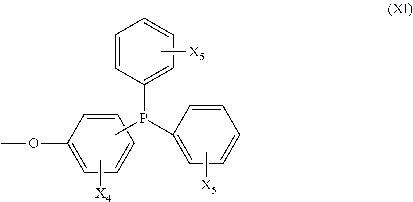
wherein each X is independently a hydrogen or a substituent group.

13. The phosphazene compound of claim 10, wherein each Q⁴ group is independently a linear or branched alkoxyl group containing from 1 to 20 carbon atoms, a phenoxy group, a phenoxy group that contains alkyl substitution, a phenoxy group that contains phenyl substitution, a phenoxy group that contains aryloxy substitution, or a phenoxy group that contains aralkyl substitution.

14. The phosphazene compound of claim 10, wherein at least Q³ or Q⁴ group contains a hydroxyl, ether, tertiary amine, ester, urethane or urea group.

15. A mixture comprising the phosphazene compound of claim 10 and at least one other flame retardant.

16. A polymer composition comprising a combustible polymer having mixed therein an effective amount of the phosphazene of claim 10.

17. The polymer composition of claim 16, further comprising at least one filler, antioxidant, UV stabilizer, fluorinated polymer, lubricant or impact modifier.
